(19) United States
(12) Patent Application Publication
(10) Pub. No.: US 2009/0252156 A1
(43) Pub. Date: Oct. 8, 2009

(54) Voice over internet protocol switch devices

(76) Inventors: Paul Broadhurst, West Sussex (GB); Andre Roodbeen, Veenendaal (NL)

Correspondence Address: ABELMAN, FRAYNE & SCHWAB, 666 THIRD AVENUE, 10TH FLOOR, NEW YORK, NY, 10017, US

(21) Appl. No.: 12/380,556

(22) Filed: Feb. 27, 2009

(30) Foreign Application Priority Data
Oct. 14, 2006 (GB) GB0620431.7

(51) Int. Cl. H04L 12/66

(52) U.S. Cl. 370/352

(57) ABSTRACT

A VOIP switch device has a first terminal (1) for connection to a conventional telephone line, a second terminal (2) for connection to a VOIP line, a third terminal (3) for connection to a subscriber's telephone, a first switch capable of occupying a first condition in which the first and third terminals are interconnected and a second condition in which the second and third terminals are interconnected, the first switch occupying the first condition for receipt of incoming calls via the first terminal and the second condition for outgoing calls via the second terminal until receipt of an incoming call via the second terminal whereupon the first switch occupies the second condition for both incoming and outgoing calls via the second terminal. The device has reset switching circuitry (13, 14) which is operative to cause the first switch to revert to the first condition.

### FIELD OF THE INVENTION

This Invention Relates to Voice Over Internet Protocol (Voip) Switch Devices.

### BACKGROUND TO THE INVENTION

VOIP switch devices are used automatically to change a telephony service feed from a conventional telephone line to an internet connection during the time before the subscriber's telephone number is transferred from the old to the new service provider. Without such a switch device, the subscriber has to change cables after the number is transferred from the conventional telephone provider to the VOIP provider, and the subscriber cannot be called until that has been done. If the conventional telephone line has already been disconnected or disabled, but the subscriber has not changed the cabling, the subscriber cannot be reached by telephone at all.

A known VOIP switch device is described herein with reference to FIG. 1 of the accompanying drawings. The invention aims to provide an improved VOIP switch device having the function of this known switch device.

### SUMMARY OF THE INVENTION

According to the invention there is provided a VOIP switch device comprising a first terminal for connection to a conventional telephone line, a second terminal for connection to a VOIP line, a third terminal for connection to a subscriber's telephone, a first switch capable of occupying a first condition in which the first and third terminals are interconnected and a second condition in which the second and third terminals are interconnected, the first switch occupying the first condition for receipt of incoming calls via the first terminal and the second condition for outgoing calls via the second terminal until receipt of an incoming call via the second terminal whereupon the first switch occupies the second condition for both incoming and outgoing calls via the second terminal, wherein the device has reset switching circuitry which is operative to cause the first switch to revert to the first condition.

A VOIP switch device according to the invention thus has the facility to revert to receiving incoming calls via the conventional telephone line after it has used the VOIP line exclusively for both incoming and outgoing calls.

The second condition of the first switch may be the default condition which the first switch adopts when electrical power is removed, and in this case the first incoming call via the second terminal may de-energise the first switch to cause it to establish an enduring interconnection between the second and third terminals, until the reset switching circuitry is operative to restore power to the first switch and thus cause it to adopt the first condition.

A VOIP switch device operable in this way is relatively efficient, because when the first switch occupies the second condition, and under normal circumstances the first switch will occupy the second condition for the vast majority of its operational life, it does not draw any direct current from the VOIP line to which the second terminal is connected.

The first switch is preferably a relay which connects the third terminal either to the first terminal (in the first condition) or to the second terminal (in the second condition).

The reset switching circuitry may comprise a manually operable reset switch and a reset relay latched to the first relay such that closure of the reset switch re-energises the first relay.

The hardware of the preferred VOIP switch device according to the invention may be designed in such a way that the same printed circuit board can be used to provide a non-latching VOIP switch (functioning as in FIG. 1 of the accompanying drawings) or a latching version (as shown in FIGS. 2 and 3), certain components being omitted or included depending on whether a latching or non-latching VOIP switch device is required.

The VOIP switch device may advantageously further comprise line monitoring circuitry operable to monitor one of the first and second terminals to detect an interruption of service on a line connected to the terminal, in response to detecting an interruption of service on the line connected to the terminal, to determine whether the terminal is connected to the third terminal by the first switch, and, in response to determining that the terminal is connected to the third terminal by the first switch, to cause the first switch to connect the other of the first and second terminals to the third terminal.

In this way the VOIP switch device can detect an interruption of service on one of the lines to which the switch device is connected, can determine whether the subscriber's telephone is connected to that line by the first switch and, if so, can cause the first switch to connect the subscriber's telephone to the other line.

The line monitoring circuitry may advantageously be operable to monitor the second terminal to detect an interruption of service on a VOIP line connected to the second terminal, in response to detecting an interruption of service on the VOIP line to determine whether the second terminal is connected to the third terminal by the first switch, and, in response to determining that the second terminal is connected to the third terminal by the first switch, to cause the first switch to connect the first terminal to the third terminal.

The line monitoring circuit may advantageously be operable to monitor the first and second terminals to detect an interruption of service on the lines connected to the first and second terminals, in response to detecting an interruption of service on a line connected to one of the first and second terminals, to determine whether the terminal is connected to the third terminal by the first switch, and, in response to determining that the terminal is connected to the third terminal by the first switch, to cause the first switch to connect the other of the first and second terminals to the third terminal.

### BRIEF DESCRIPTION OF THE DRAWINGS

The invention will now be further described, by way of example, with reference to the accompanying drawings, in which:

FIG. 1 is a block diagram of a known non-latching VOIP switch device;

FIG. 2 is a block diagram of a first embodiment of latching VOIP switch device according to the invention;

FIG. 3 is a circuit diagram of the switch device of FIG. 2;

FIG. 4 is a circuit diagram of circuitry which can be adapted to operate either in latching or non-latching mode;

FIG. 5 is a block diagram of a second embodiment of VOIP switch device according to the invention;

FIG. 6 is a circuit diagram of a VOIP line alive detector of the switch device of FIG. 5;

FIG. 7 is a circuit diagram of a controller of the switch device of FIG. 5;

FIG. 8 is a circuit diagram of Pots line monitoring circuitry; and

FIG. 9 is a circuit diagram of a back-up power supply of the switch device of FIG. 5.

### DETAILED DESCRIPTION

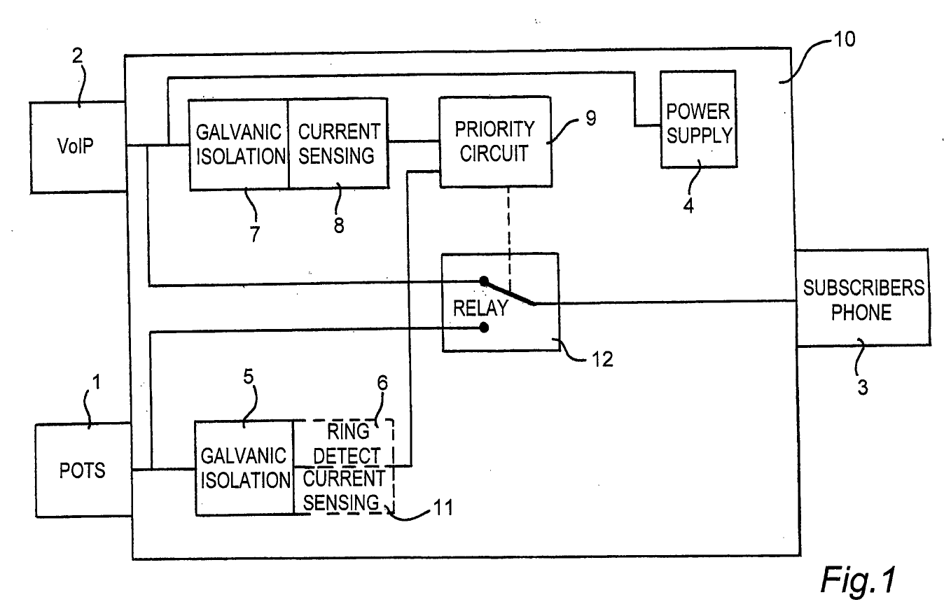

Referring to FIG. 1, the known switch device has a rectangular casing 10 with a first terminal 1 for connection to a conventional public service telephone network (labelled POTS for Plain Old Telephony Service), a second terminal 2 for connection to an internet line (for VOIP) and a third terminal 3 for connection to a subscriber's telephone.

Within the casing 10, a power supply 4 feeds a ring detect function 6 and a line current sensing function 11 for the conventional telephone line, and a line current sensing function 8 for the VOIP line. Galvanic isolation circuits 5 and 7 are provided between the terminal 1 and current sensing function 11 and between the terminal 2 and current sensing function 8, respectively. Signals from the respective ring detect function 6 and current sensing functions 8 and 11 are fed to a priority circuit 9 which controls a bi-stable relay 12. In “passive” default condition, the relay 12 interconnects terminals 2 and 3 (illustrated) and in a second “active” condition the relay 12 interconnects the terminals 1 and 3, and this happens if an incoming call occurs on the telephone line 1.

On installation of the switch device, the subscriber can use the telephone line to receive calls via terminal 1 but can already make outgoing calls on the VOIP line via terminal 2. When a call comes in via the telephone line on terminal 1, the switch device automatically connects the first and third terminals 1 and 3. When the telephone line is disabled, the switch device automatically connects the terminals 2 and 3 so the subscriber can both receive incoming calls and make outgoing calls via the VOIP line through terminal 2.

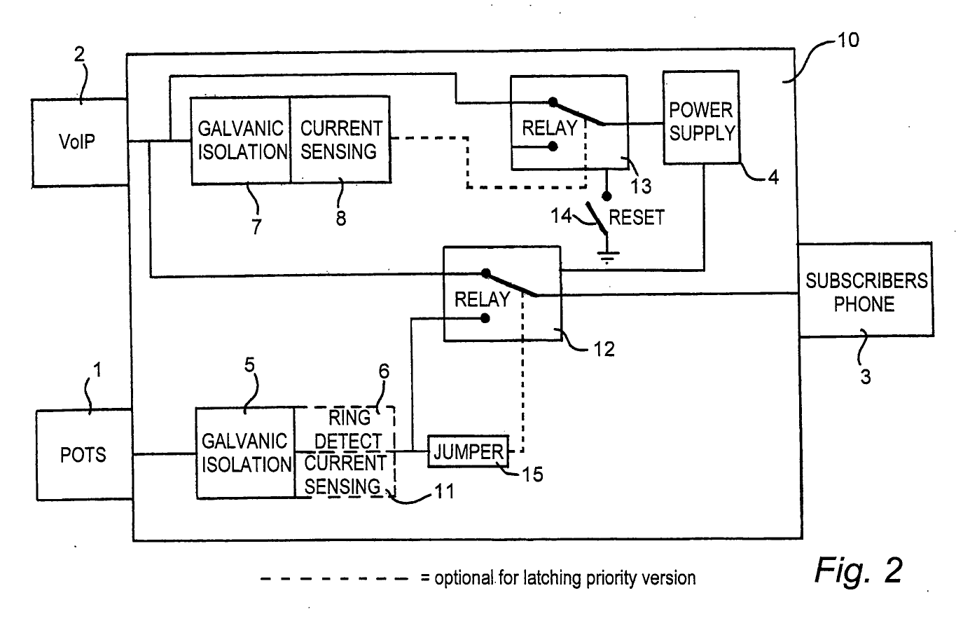

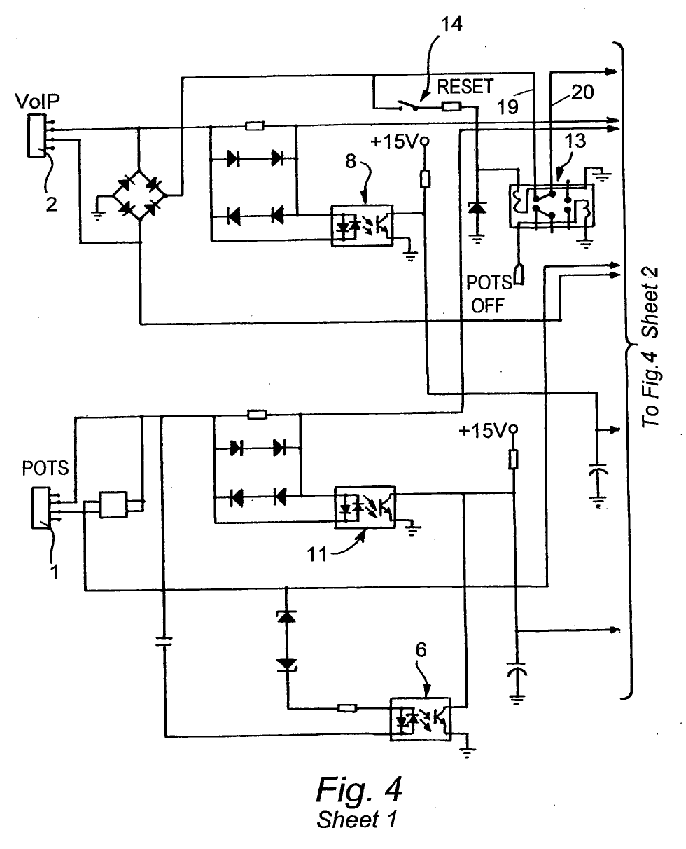

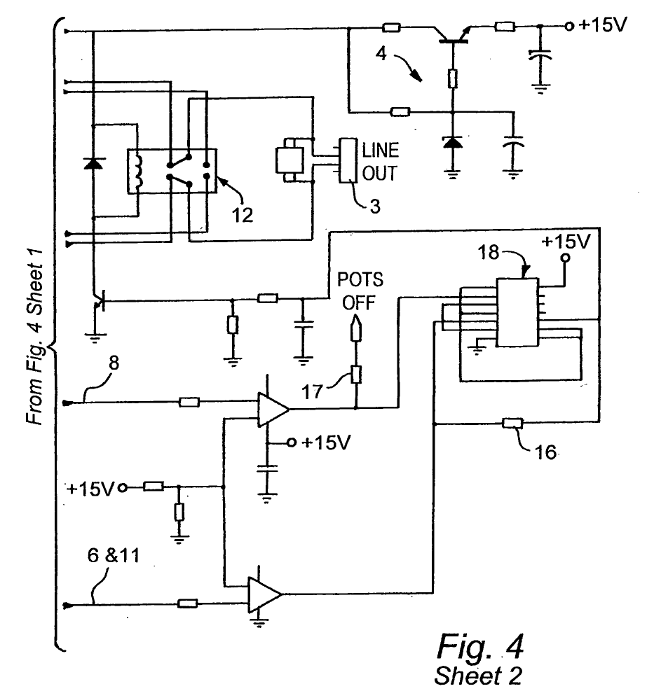

FIG. 2 is a corresponding block diagram of a VOIP switch device representing a first embodiment of the present invention, and parts corresponding to those of FIG. 1 bear the same reference numerals. Instead of the priority circuit 9, the circuit of FIG. 2 has reset switching circuitry comprising a latching relay 13 and a manually closable reset switch 14. When the VOIP switch device of FIG. 2 is installed, the subscriber can make outgoing calls via the VOIP line and receive incoming calls via the telephone line. At the first incoming call on the VOIP line, the switch device interconnects terminals 2 and 3 so that the subscriber's telephone is connected to the VOIP line for both incoming and outgoing calls. This connection is enduring in the sense that it remains in place until the reset switch 14 is closed, whereupon the relay 12 interconnects the first and third terminals 1 and 3. The meaning of the block 15 (referenced “Jumper”) is explained in the following description of FIG. 4.

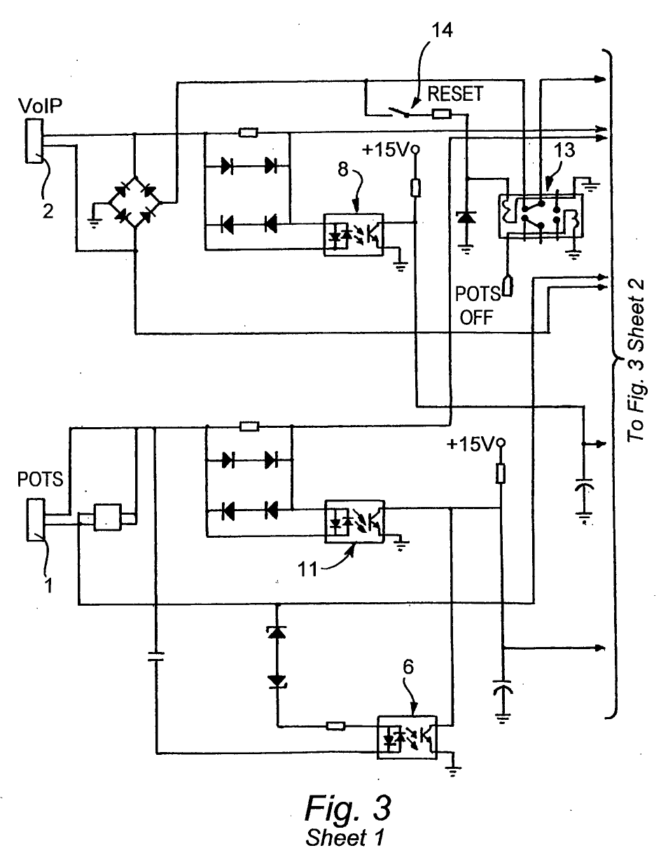

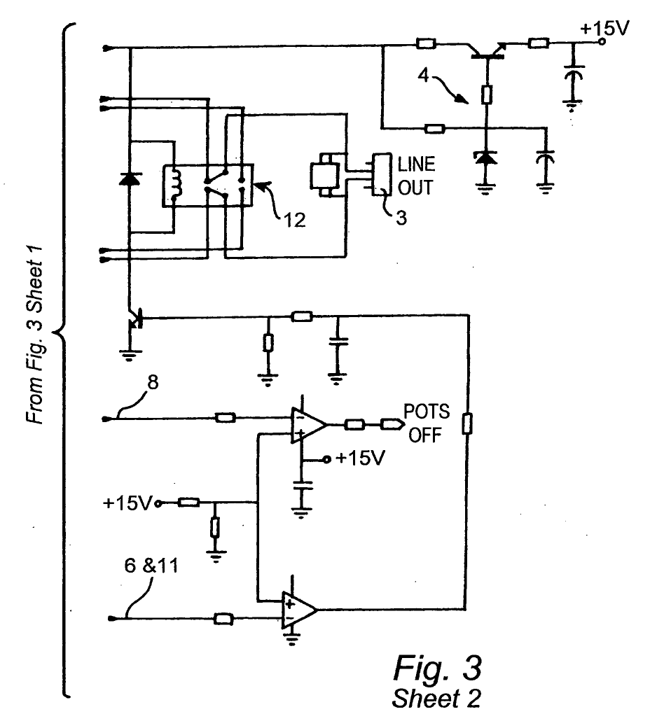

FIG. 3 is an electrical circuit diagram of the VOIP switch device of FIG. 2, and corresponding parts bear the same reference numerals.

In FIG. 3, the relay 12 is shown in the default condition in which the terminals 2 and 3 are interconnected, for incoming and outgoing calls via the VOIP line. If the reset switch 14 is depressed, the latching relay 13 reconnects the power supply to the circuit which reverts to its condition where the terminals 1 and 3 are interconnected (corresponding to a call coming in on the telephone line 1), enabling the subscriber to maintain use of the conventional telephone line for incoming calls for the time being. Once there is an incoming call on VOIP, it reverts to the passive state. Normally the reset switch 14 is closed to test the switch device, after installation of the latter.

The hardware of the first embodiment is preferably designed in such a way that the same printed circuit board (PCB) can be used to provide either a non-latching VOIP switch device (functioning as in FIG. 1) or a latching version (as in FIGS. 2 and 3). FIG. 4 is a circuit diagram of such a dual function PCB where parts corresponding to those of FIG. 3 bear the same reference numerals. For the non-latching version, the reset switch 14, the relay 13 and the resistors 16 and 17 are omitted, the pins 19 and 20 of the relay 13 on the PCB having to be connected by a jumper. For the latching version, the circuit 18 (fulfilling the function of the priority circuit 9 of FIG. 1) is omitted. Reference 15 in FIG. 2 is indicative of the connection from the ring detect function 6 and the current sensing function 11 to the relay 12 in the latching version.

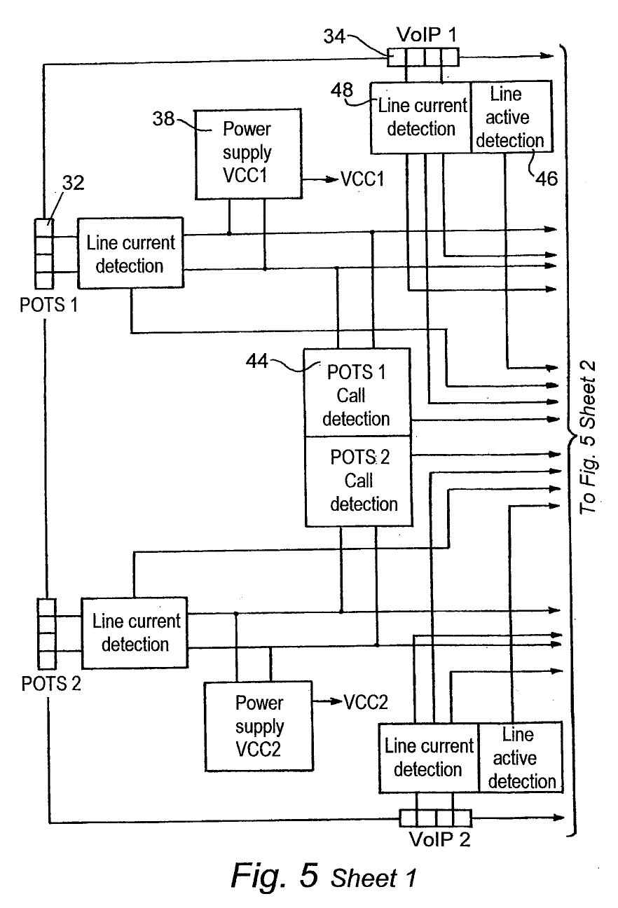

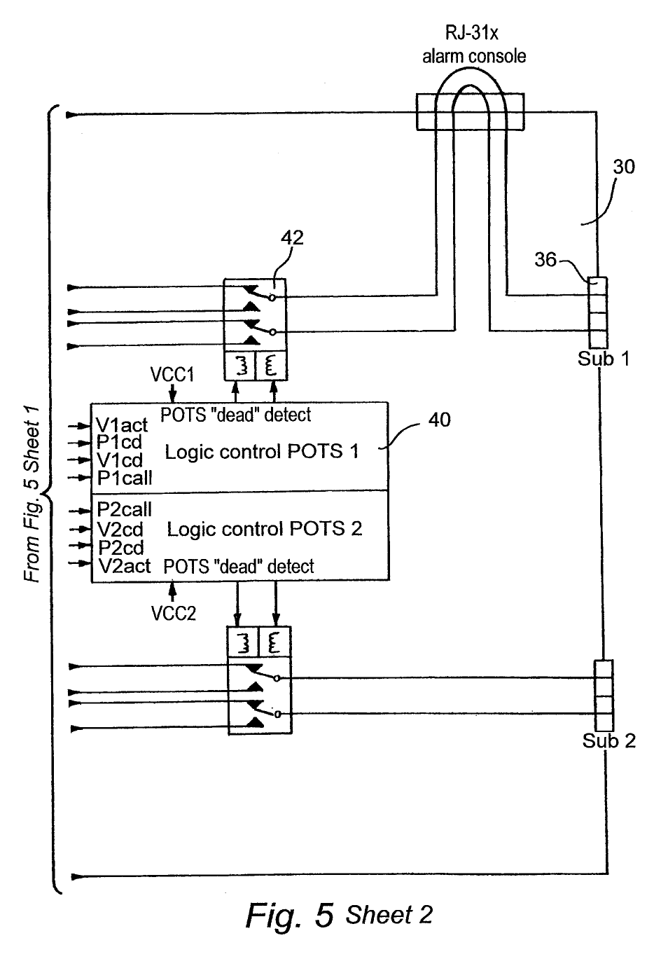

FIG. 5 is a block diagram of a VOIP switch device representing a second embodiment of the present invention. The VOIP switch device of FIG. 5 is capable of connecting a first pair of conventional telephone and VOIP line terminals (labelled “POTS1” and “VOIP1”) to a first subscriber's telephone line terminal (labelled “Sub1”) and a second pair of conventional telephone and VOIP line terminals (labelled “POTS2” and “VOIP2”) to a second subscriber's telephone line terminal (labelled “Sub2”). In order to avoid unnecessary duplication of description, the circuit will only be described to the extent that it relates to connection of the first pair of conventional telephone and VOIP line terminals to the first subscriber's telephone line.

The VOIP switch device 30 of FIG. 5 comprises a first terminal 32 for connection to a conventional telephone line, a second terminal 34 for connection to a VOIP line and a third terminal 36 for connection to a subscriber's telephone.

A power supply 38 is connected across a conventional telephone line connected to the first terminal 32, the power supply 38 drawing current from the telephone line to supply a logic control circuit 40 comprising a microcontroller and a conventional telephone line dead detect circuit that controls a relay 42 to connect the third terminal 36 to either the first terminal 32 or the second terminal 34.

The switch device 30 is operable in a similar manner to the switch device 10 of FIGS. 1 to 4, in that it includes a ring detect circuit 44 operable to detect an incoming call at the first terminal 32. As for the switch device 10, the microcontroller is operable to control the relay 42 to connect the second terminal 34 to the third terminal 36 to enable a subscriber to make outgoing calls using a VOIP line connected to the second terminal 34, and, in response to detection of an incoming call on a conventional telephone line connected to the first terminal 32 by the ring detect circuit 44, to control the relay 42 to connect the first terminal 32 to the third terminal 36 to enable the subscriber to receive the incoming call.

A line active detect circuit 46 connected to the second terminal 34 is operable to determine whether the VOIP line is alive, and, if the VOIP line is dead, to cause the microcontroller to connect the first terminal 32 to the third terminal 36, so that both incoming and outgoing calls can be made using the Pots line connected to the first terminal. This state is maintained until the VOIP line comes alive again.

It is envisaged that the use of the switch device 30 would be somewhat different from the use of the switch device 10, which is intended to enable incoming calls to be received from a conventional telephone line until incoming calls can be received from VOIP line and the conventional telephone line is cut off.

The switch device 30 can be used in this way but is intended primarily for use where the conventional telephone line is not cut off once incoming calls can be received from the VOIP line.

The switch device 30 includes a line current detect circuit 48 connected to the VOIP line. The line current detect circuit 48 monitors whether the telephone is off-hook.

If the line active detect circuit 46 detects an interruption of service on the VOIP line, it causes the microcontroller to control the relay 42 to connect the first terminal 32 to the third terminal 36, so that the subscriber can make outgoing calls using the conventional telephone line connected to the first terminal 32. This would be useful, for example, to make an emergency call in the event that the VOIP line connected to the second terminal 34 were to suffer an interruption of service, for example due to a power cut.

The conventional telephone line dead detect circuit is connected to the power supply 38. If the conventional telephone line dead detect circuit detects an interruption of service on the conventional telephone line, it is operable, in conjunction with a capacitor (C10 in FIG. 9), to control the relay 42 to connect the second terminal 34 to the third terminal 36, so that the subscriber can make outgoing calls using the VOIP line. The conventional telephone line dead detect circuit bypasses the microcontroller, because the power supply 38 draws current from the conventional telephone line in order to supply current to the microcontroller, and in the event of an interruption of service on the conventional telephone line, the supply of current for the microcontroller will also be interrupted.

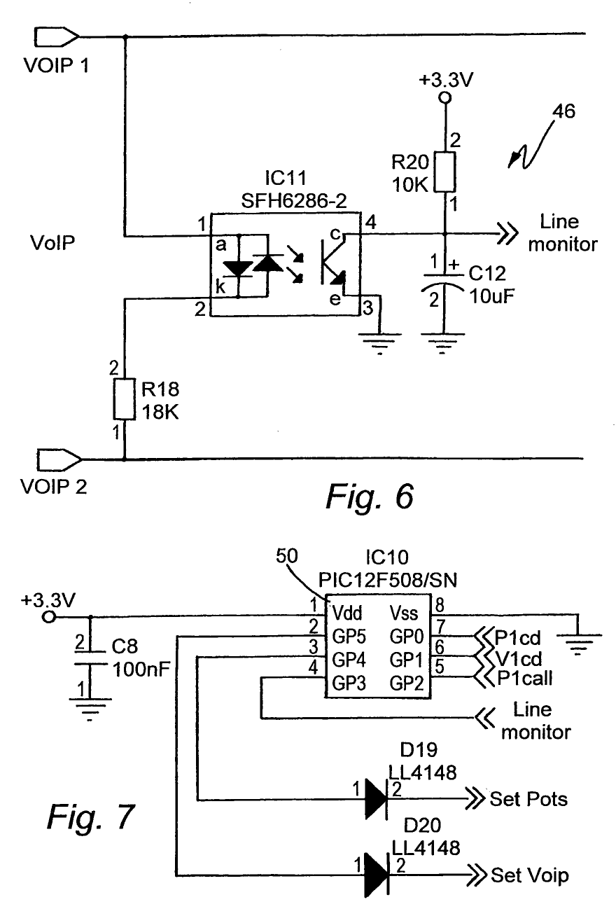

FIG. 6 shows the line active detect circuit 46, which comprises an optocoupler IC11 connected across the VOIP line. While the VOIP line is active, current flows through resistor R20 and the output of the circuit (labelled “Line Monitor”) is low, and goes high in the event of an interruption of service on the VOIP line. The output of the line active detect circuit 46 is labelled “V1 act” in FIG. 5.

The microcontroller, shown in FIG. 7 denoted by reference numeral 50, causes the “Set Pots” line, which is connected to the relay 42, to go high for a sufficient time to cause the relay to connect the first terminal 32, i.e. the conventional telephone line, to the third terminal 36.

The “Set Voip” line shown in FIG. 7 is used to enable the subscriber to make an outgoing call using the VOIP line, or once the VOIP line is capable of receiving incoming calls. It is not used in the event of an interruption of service on the conventional telephone line.

The first terminal 32 remains connected to the third terminal 36 until service on the VOIP line is resumed.

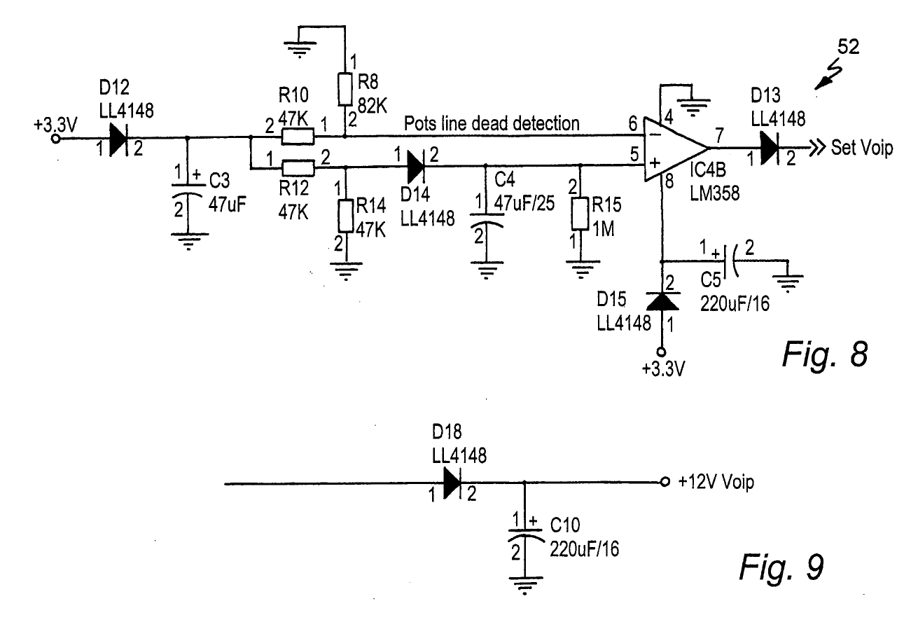

FIG. 8 shows the conventional telephone line dead detect circuit 52, which is provided with a 3.3V power supply by the power supply 38.

During normal service on the conventional telephone line, the arrangement of diodes D12 and D14 and resistors R8, R10, R12, R14 and R15 causes the voltage at the inverting input of the op-amp IC4B to be greater than the voltage at the non-inverting input of the op-amp, so that the output of the op-amp (labelled “Set Voip”) is low.

If there is an interruption of service on the conventional telephone line, the voltage at the inverting input of the op-amp IC4B will fall almost immediately to zero. The op-amp will continue to operate for a short time by drawing a current from capacitor C5, which is connected across the 3.3V power supply. The voltage at the non-inverting input will fall more slowly than the voltage at the inverting input, because of the capacitor C4 connected between the non-inverting input and ground. The output of the op-amp will therefore briefly go high. The output of the op-amp is used to drive a transistor (not shown) connected to the relay 42.

Turning to FIG. 9, this shows a capacitor C10 that is connected from a 12V line of the VOIP line to ground. The capacitor is connected through the transistor to the relay 42 and provides the current necessary to operate the relay to connect the second terminal 34 to the third terminal 36, so that the subscriber's telephone is connected to the VOIP line.

1. A VOIP switch device comprising a first terminal for connection to a conventional telephone line, a second terminal for connection to a VOIP line, a third terminal for connection to a subscriber's telephone, a first switch capable of occupying a first condition in which the first and third terminals are interconnected and a second condition in which the second and third terminals are interconnected, the first switch occupying the first condition for receipt of incoming calls via the first terminal and the second condition for outgoing calls via the second terminal until receipt of an incoming call via the second terminal whereupon the first switch occupies the second condition for both incoming and outgoing calls via the second terminal, wherein the device has reset switching circuitry which is operative to cause the first switch to revert to the first condition.

2. A VOIP switch device according to claim 1, wherein the second condition of the first switch is the default condition which the first switch adopts when electrical power is removed.

3. A VOIP switch device according to claim 2, wherein the first incoming call via the second terminal de-energises the first switch to cause it to establish an enduring interconnection between the second and third terminals, until the reset switching circuitry is operative to restore power to the first switch and thus cause it to adopt the first condition.

4. A VOIP switch device according to claim 1, wherein the first switch is a relay which connects the third terminal either to the first terminal (in the first condition) or to the second terminal (in the second condition).

5. A VOIP switch device according to claim 4, wherein the reset switching circuitry comprises a manually operable reset switch and a reset relay latched to the first relay such that closure of the reset switch re-energises the first relay.

6. A VOIP switch device according to claim 1, further comprising line monitoring circuitry operable to monitor one of the first and second terminals to detect an interruption of service on a line connected to the terminal, in response to detecting an interruption of service on the line connected to the terminal, to determine whether the terminal is connected to the third terminal by the first switch, and, in response to determining that the terminal is connected to the third terminal by the first switch, to cause the first switch to connect the other of the first and second terminals to the third terminal.

7. A VOIP switch device according to claim 6, wherein the line monitoring circuit is operable to monitor the first and second terminals to detect an interruption of service on the lines connected to the first and second terminals, in response to detecting an interruption of service on a line connected to one of the first and second terminals, to determine whether the terminal is connected to the third terminal by the first switch, and, in response to determining that the terminal is connected to the third terminal by the first switch, to cause the first switch to connect the other of the first and second terminals to the third terminal.
